(19) United States
(12) Patent Application Publication
(10) Pub. No.: US 2025/0191805 A1
(43) Pub. Date: Jun. 12, 2025

(54) STRUCTURE WITH BARRIER-FREE METAL VIA AND METAL WIRE INCLUDING NON-COPPER CONDUCTOR, AND METHOD TO FORM SAME

(71) Applicant: GlobalFoundries U.S. Inc., Malta, NY (US)

(72) Inventor: Ravi Prakash Srivastava, Clifton Park, NY (US)

(21) Appl. No.: 18/531,839

(22) Filed: Dec. 7, 2023

(51) Int. Cl. H01B 1/02; H01B 1/04

(52) U.S. Cl. CPC H01B 1/02; H01B 1/04

(57) ABSTRACT

A structure including a barrier-free metal via over a substrate and in a dielectric layer. The structure further includes a barrier-free metal wire in the dielectric layer and over the barrier-free metal via and coupled to at least an exposed portion of the barrier-free metal via. The barrier-free metal via and the barrier-free metal wire each include a non-copper conductor. By using non-copper conductors in the structure, the structure is substantially without liners and has improved performance without creating or increasing parasitic capacitance.

### BACKGROUND

Embodiments of the disclosure relate generally to integrated circuit (IC) structures. More particularly, the disclosure relates to IC structures with barrier-free metal wires and barrier-free metal vias including a non-copper conductor.

Integrated circuit (IC) chips have billions of devices thereon, such as transistors, capacitors, and resistors. To fit more devices on each chip, device dimensions and layout area (i.e., the area the device takes up on a chip) must shrink. An aspect of reducing device layout area includes reducing the dimensions of metal layers, interconnects, vias, etc. Conventional metal wires and vias include copper and metal liners to prevent copper ions from diffusing out of the via and into the semiconducting devices thereunder, which destroys the semiconducting ability of the devices. However, as vias shrink, the via liner takes up a larger proportion of the volume in the via. In some cases, there may be more liner material than conductive copper in the via or wire.

### SUMMARY

An aspect of the disclosure includes a structure, including a barrier-free metal via over a substrate and in a dielectric layer; a barrier-free metal wire in the dielectric layer and over the barrier-free metal via and coupled to at least an exposed portion of the barrier-free metal via, wherein the barrier-free metal via and the barrier-free metal wire each include a non-copper conductor.

Another aspect of the disclosure includes a structure, including a low-resistivity interconnect layer over a substrate, the low-resistivity interconnect layer including a barrier-free metal via and in a dielectric layer; and a barrier-free metal wire in the dielectric layer, the barrier-free metal via and coupled to at least an exposed portion of the barrier-free metal via, wherein the barrier-free metal via and the barrier-free metal wire each include a non-copper conductor.

Another aspect of the disclosure includes a method of forming a structure, including forming a barrier-free metal via over a substrate and in a dielectric layer; and forming a barrier-free metal wire in the dielectric layer and over the barrier-free metal via and coupled to at least an exposed portion of the barrier-free metal via, wherein the barrier-free metal via and the barrier-free metal wire each include a non-copper conductor.

It should be noted that all aspects, examples, and features of disclosed embodiments mentioned herein can be combined in any technically possible way. That is, two or more aspects of any of the disclosed embodiments, including those described in this summary section, may be combined to form implementations not specifically described herein. The details of one or more implementations are set forth in the accompanying drawings and the description below. Other features, objects and advantages will be apparent from the description and drawings, and from the claims.

### BRIEF DESCRIPTION OF THE DRAWINGS

The embodiments of this disclosure will be described in detail, with reference to the following figures, wherein like designations denote like elements, and wherein:

FIG. 1 shows a top-down perspective of a structure with barrier-free metal wires and barrier free metal vias, according to embodiments of the disclosure.

FIG. 2 shows a cross-sectional view of a structure including barrier-free metal wires and barrier-free metal vias, according to embodiments of the disclosure.

FIG. 3 shows a shows a cross-sectional view of a structure including barrier-free metal wires and barrier-free metal vias, according to embodiments of the disclosure.

FIG. 4A shows a cross-sectional view of a structure including barrier-free metal wires and barrier-free metal vias, according to embodiments of the disclosure.

FIG. 4B shows a partial perspective view of a structure including barrier-free metal wires and barrier-free metal vias, according to embodiments of the disclosure.

FIG. 5 shows a cross-sectional view of a process to pattern trenches in a dielectric according to embodiments of the disclosure.

FIG. 6 shows a cross-sectional view of processes to form barrier-free metal vias according to embodiments of the disclosure.

FIG. 7 shows a cross-sectional view of a process to pattern trenches according to embodiments of the disclosure.

FIG. 8 shows a process to form barrier-free metal wires according to embodiments of the disclosure.

It is noted that the drawings of the disclosure are not necessarily to scale. The drawings are intended to depict only typical aspects of the disclosure, and therefore should not be considered as limiting the scope of the disclosure. In the drawings, like numbering represents like elements between the drawings.

### DETAILED DESCRIPTION

In the following description, reference is made to the accompanying drawings that form a part thereof, and in which is shown by way of illustration specific illustrative embodiments in which the present teachings may be practiced. These embodiments are described in sufficient detail to enable those skilled in the art to practice the present teachings, and it is to be understood that other embodiments may be used and that changes may be made without departing from the scope of the present teachings. The following description is, therefore, merely illustrative.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present.

Reference in the specification to “one embodiment” or “an embodiment” of the present disclosure, as well as other variations thereof, means that a particular feature, structure, characteristic, and so forth described in connection with the embodiment is included in at least one embodiment of the present disclosure. Thus, the phrases “in one embodiment” or “in an embodiment,” as well as any other variations appearing in various places throughout the specification are not necessarily all referring to the same embodiment. It is to be appreciated that the use of any of the following “/,” “and/or,” and “at least one of,” for example, in the cases of “A/B,” “A and/or B,” and “at least one of A and B,” is intended to encompass the selection of the first listed option (A) only, or the selection of the second listed option (B) only, or the selection of both options (A and B). As a further example, in the cases of “A, B, and/or C” and “at least one of A, B, and C,” such phrasing is intended to encompass the first listed option (A) only, or the selection of the second listed option (B) only, or the selection of the third listed option (C) only, or the selection of the first and the second listed options (A and B), or the selection of the first and third listed options (A and C) only, or the selection of the second and third listed options (B and C) only, or the selection of all three options (A and B and C). This may be extended, as readily apparent by one of ordinary skill in the art, for as many items listed.

As used herein, “barrier-free” and/or “liner-less” materials refer to metal wires, vias, and other conductive interconnects in integrated circuits that are without barriers or liners therein. A barrier or liner is used in conductive metal wires and interconnects to avoid electromigration. Electromigration is a phenomenon where conductive metal atoms (e.g., copper) in conductive interconnect layers are displaced over time due to current flow therein. When conductive metal atoms migrate and subsequently integrate into a semiconducting material, the semiconducting attributes of that material are destroyed because the device begins conducting as a conductor (e.g., a metal) would. Electromigration is characteristic of, e.g., copper. Some conductive materials described herein are not susceptible to electromigration, due to their particular compositions. Therefore, “barrier-free” materials exclude materials that are susceptible to electromigration, and do not have include barriers or liners thereon. Hence, they are “barrier-free” and/or “liner-less.” Any materials described herein as being barrier-free and/or liner-less may have a direct interface with adjacent or surrounding materials, e.g., an inter-layer dielectric layer in which the barrier-free material is formed.

Embodiments of the disclosure include a barrier-free metal wire and/or via having a non-copper conductor, and methods to form the same. The structure includes a barrier-free metal via over a substrate and in a dielectric layer. The structure further includes a barrier-free metal wire in the dielectric layer and over the barrier-free metal via and coupled to at least an exposed portion of the barrier-free metal via. The barrier-free metal via and the barrier-free metal wire each include a non-copper conductor. By using non-copper conductors in the structure, the structure is substantially without liners and has improved performance without creating or increasing parasitic capacitance.

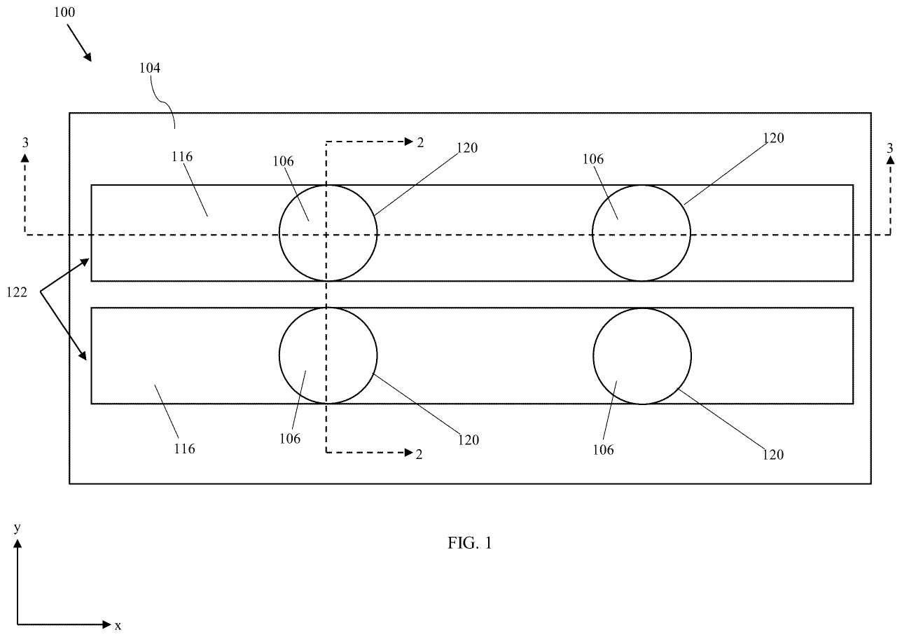

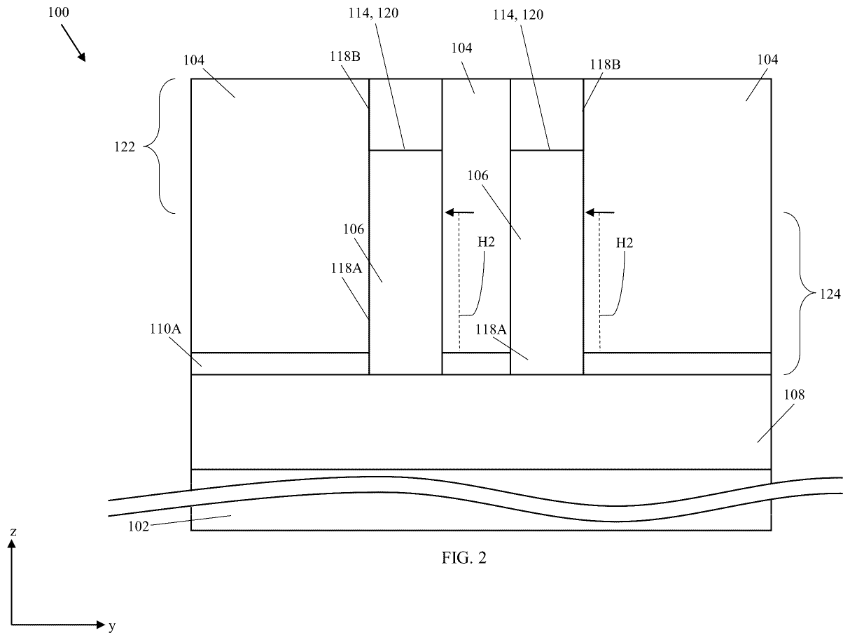

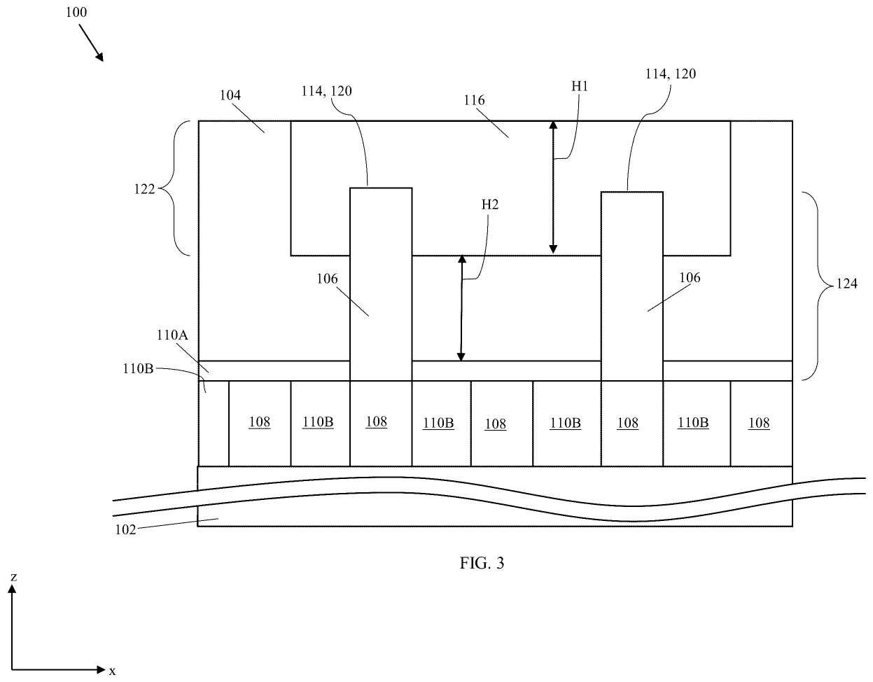

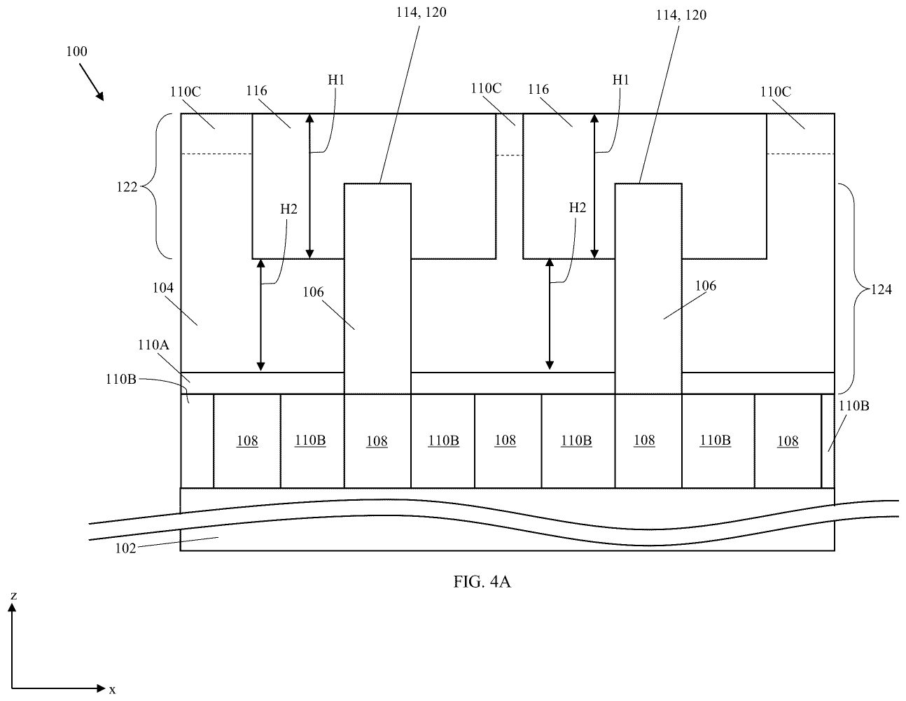

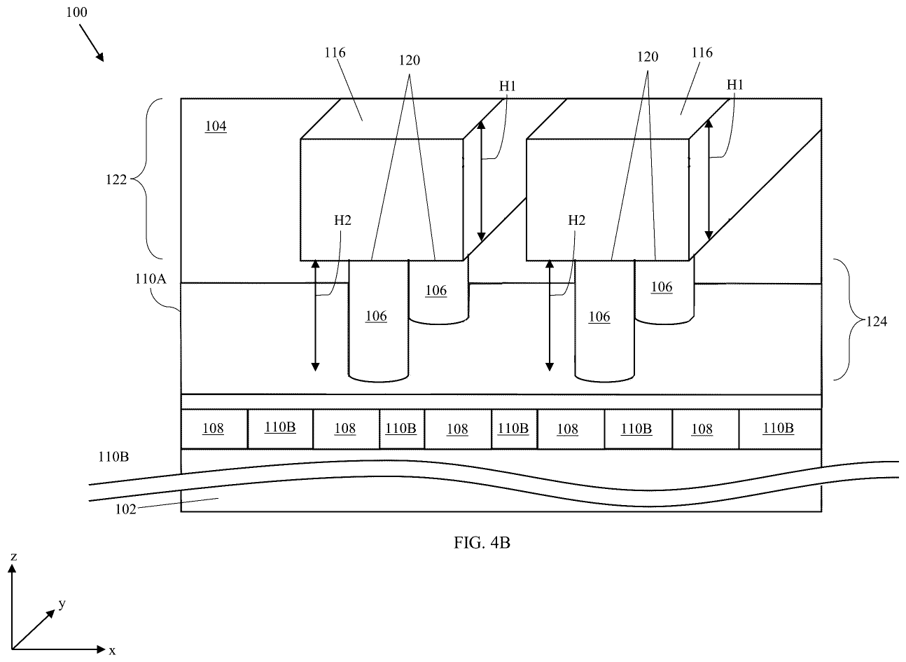

FIGS. 1-4B show various perspectives of a structure 100, according to embodiment of the disclosure. Specifically, FIG. 1 shows a top-down view of structure 100 in the x-y plane according to implementations of the disclosure. FIGS. 2-4A show various views of structure 100 in the y-z plane. Specifically, FIG. 2 shows a cross-sectional view of structure 100 along view line 2-2 in FIG. 1; FIG. 3 shows a cross-sectional view of structure 100 along view line 3-3 in FIG. 1; and FIG. 4A shows a cross-sectional view of an alternative embodiment of structure 100 according to the disclosure. FIG. 4B shows a partial perspective view of further embodiments of structure 100 in three dimensional (x, y, z) space, according to the disclosure. Structure 100 may take the form of an integrated circuit (IC) structure or any other microelectronic structure or semiconducting devices, including transistors, resistors, capacitors, etc. (none shown).

Still referring to FIGS. 2-4B, structure 100 may include a substrate 102. FIGS. 2-4B include broken lines to indicate an indeterminate number of metal and device layers between the illustrated sections. Substrate 102 may provide a base on or in which structure 100 may be formed, and mechanically supports structure 100. Substrate 102 may take the form of any known or future substrates on which structure 100 may be formed, such as, e.g., a semiconductor wafer or a semiconductor-on-insulator (“SOI”) wafer. That is, substrate 102 may include a semiconductor material, including, e.g., silicon, germanium, silicon germanium, silicon carbide, and those consisting essentially of one or more III-V compound semiconductors, or any other common IC semiconductor substrates.

Referring to FIGS. 1-4B, structure 100 may include a dielectric layer 104 over substrate 102. Dielectric layer 104 may be an insulative (i.e., non-conductive) layer on or in which other structures may be formed. Here, dielectric layer 104 may take the form of an interlayer dielectric layer (ILD), which may physically, electrically, and/or thermally isolate metal layers within an integrated circuit. As shown in FIGS. 1-4B, dielectric layer 104 may electrically isolate barrier-free metal vias 106 and/or barrier-free metal wires 108 from one another. Barrier-free metal via 106 is a conductive structure interconnecting metal wires 108 (i.e., conductive metal wires) and which includes materials that do not require a liner because barrier-free metal vias 106 include non-copper conductors that are not susceptible to electromigration, as discussed fully herein. Similarly, barrier-free metal wire 108 is a conductive structure interconnecting other metal wires 108 and devices thereunder (not shown) and do not require a liner because barrier-free metal wires 108 include non-copper conductors that are not susceptible to electromigration. Because barrier-free metal vias 106 and barrier-free metal wires 116 are barrier-free (i.e., liner-less), dielectric layer 104 may directly physically interface with barrier-free vias 106 and barrier-free metal wires 116. Suitable dielectric materials for dielectric layer 104 may include, but are not limited to, carbon-doped silicon oxide materials; fluorinated silicate glass (FSG); organic polymeric thermoset materials; silicon oxycarbide; SiCOH dielectrics; fluorine doped silicon oxide; spin-on glasses; silsesquioxanes, including hydrogen silsesquioxane (HSQ), methyl silsesquioxane (MSQ) and mixtures or copolymers of HSQ and MSQ; benzocyclobutene (BCB)-based polymer dielectrics, and any silicon-containing low-k dielectric. In one non-limiting example, dielectric layer 104 may include one or more variations of silicon oxide (SiO₂). Dielectric layer 104 may include any number of dielectric materials. Any number of additional dielectric layers may be provided over substrate 102 in a known fashion, i.e., providing back-end-of-line (BEOL) interconnect layers. For example, structure 100 may include additional dielectric layers 110A and 110B under dielectric layer 104, as shown in FIGS. 2-4B. Additional dielectric layers 110A and 110B may be similar to dielectric layer 104 in other implementations, except they may be beneath dielectric layer 104 and may include different dielectric materials. Additional dielectric layer 110B may electrically isolate metal wires 108 from one another. As shown in FIGS. 2-4B, barrier-free metal vias 106 may extend between additional dielectric layer 110A and contact metal wires 108. In one embodiment, shown in FIG. 4A, structure 100 may include optional dielectric layer 110C (illustrated in dashed lines). Optional dielectric layer 110C is similar to other dielectric layers described herein, and may be used to increase height H1 of barrier-free metal wires 116, as described fully herein. All embodiments may include or exclude optional dielectric layer 110C.

Referring to FIGS. 1-4B, as previously mentioned, structure 100 may include barrier-free metal vias 106 over substrate 102 and in dielectric layer 104. A “via” is an electrical connection between layers in an integrated circuit. Vias create the electrical network of connections that allow different parts of semiconductor devices, such as transistors, to communicate with each other. As defined herein, “barrier-free” and/or “liner-less” structures refer to metal wires, vias, and other conductive interconnects in integrated circuits that are without barriers or liners therein. Implementing structure 100 with various barrier-free structures will not increase parasitic capacitance, or may have less parasitic capacitance than conventional wiring structures. Each barrier-free metal via 106 may include an exposed portion 114. Exposed portions 114 may not be in physical contact with dielectric layer 104. As discussed fully herein, barrier-free metal wire 116 may be coupled to at least exposed portion 114 of barrier-free metal via 106, putting barrier-free metal via 106 in physical and electrical contact with barrier-free metal wire 116. A barrier-free metal wire 116 is a metal wire of electrically conductive material which does not have a liner (e.g., a refractory metal liner), as discussed herein. Barrier-free metal wire 116 may “wrap around” at least exposed portion 114 of barrier-free metal via 116, establishing electrical communication therebetween. Barrier-free metal via 106 may include a non-copper conductor. A non-copper conductor is a conductive material that does not include copper (Cu). In some implementations, non-copper conductor may include a non-copper transition metal. Transition metals are a group of elements found in the central part of the periodic table, specifically in groups 3 to 12. Transition metals exhibit characteristic properties that distinguish them from other elements. Some well-known transition metals include iron (Fe), zinc (Zn), nickel (Ni), gold (Au), ruthenium (Ru), cobalt (Co), and molybdenum (Mo). Specifically, barrier-free metal via 106 may include one of ruthenium, cobalt, and molybdenum, or any combination thereof.

In other implementations, the non-copper conductor(s) may include graphene. Graphene is a carbon allotrope; specifically, a single layer of carbon atoms arranged in a hexagonal lattice, and is a high conductor of electricity. In some implementations, barrier-free metal via 106 and barrier-free metal wire 116 may have a same material composition. However, in other implementations, barrier-free metal via 106 and barrier-free metal wire 116 have a different material composition. Because barrier-free metal via 106 may include non-copper conductor, barrier-free metal via 106 may be “chamferless” (i.e., without a chamfer, where the edges remain sharp and without beveling). A chamfer is a bevel or sloped edge on a device component. A chamfer is formed during a dual damascene process of forming, e.g., copper metal wires. Dual damascene refers to a process of forming via trenches and wiring trenches simultaneously. During a patterning step in a dual damascene process, a chamfer is typically formed in the via trench. Here, however, barrier-free metal vias 106 may be formed through a single damascene process instead of a dual damascene process because barrier-free metal vias 106 include a non-copper material. Therefore, barrier-free metal vias 106 may be chamferless. In some implementations, barrier-free metal via 106 may have a substantially circular cross-sectional area (FIG. 1). “Substantially” encompasses any insubstantial deviations in which a material retains the technical benefits and characteristics discussed herein. Although illustrated as substantially circular in cross-sectional area (FIG. 1), barrier-free metal via 106 may take the form of any shape, such as rectangles, triangles, or non-polygonal shapes. Barrier-free metal via 106 may include any number of barrier-free metal vias 106. As shown in FIGS. 2-4, barrier-free metal via 106 may include a sidewall 118A substantially vertically aligned with a sidewall 118B of the barrier-free metal wire 116.

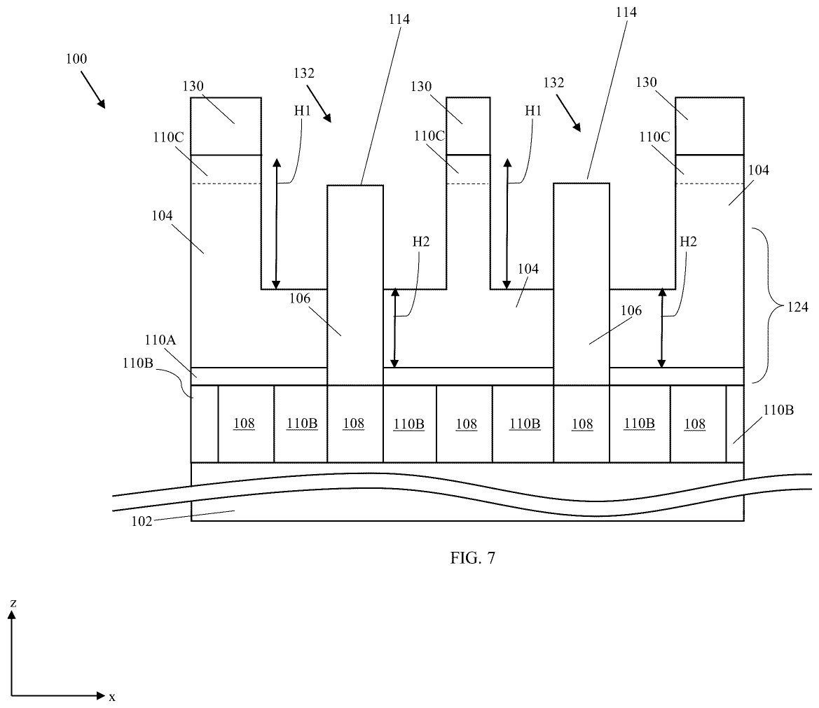

Still referring to FIGS. 1-4B, as previously mentioned, structure 100 may include barrier-free metal wires 116 within dielectric layer 104. Barrier-free metal wires 116 may be over barrier-free metal vias 106 and coupled to at least exposed portion 114 of barrier-free metal vias 106. As described, a barrier-free metal wire 116 is a metal wire structure without a liner (e.g., a refractory metal liner). Structure 100 may include any number of barrier-free metal wires 116. Similar to barrier-free metal via 106 in other implementations, barrier-free metal wires 116 may include non-copper conductor, such as a non-copper transition metal or graphene. As mentioned previously, in some implementations, barrier-free metal vias 106 and barrier-free metal wires 116 may have a same material composition. However, in other implementations, barrier-free metal vias 106 and barrier-free metal wires 116 may have a different material composition. Barrier-free metal wires 116 may take the form of various shapes, e.g., triangular, circular, etc. In some embodiments, shown in FIGS. 2-4B, barrier-free metal wires 116 may have a substantially rectangular cross-sectional area. “Substantially” encompasses any insubstantial deviations in which a material retains the technical benefits and characteristics discussed herein. Barrier-free metal wire 116 may surround exposed portion 114 of each barrier-free metal via 106. That is, barrier-free metal wires 116 may “wrap around” at least exposed portions 114 (FIG. 7) barrier-free metal vias 106, establishing electrical communication therebetween. By placing barrier-free metal vias 106 in electrical communication with a respective barrier-free metal wire 116 or barrier-free metal wires 116, the performance (i.e., conductivity) of structure 100 is increased relative to other devices while parasitic capacitance is held constant or even reduced. In some implementations, barrier-free metal wires 116 may have height H1, as illustrated in FIGS. 2-4B. Height H1 may be any possible height. As mentioned previously, optional dielectric layer 110C may be used to, e.g., modulate height H1 based on design requirements. Optional dielectric layer 110C may appear in all embodiments described herein. Barrier-free metal wires 116 may also be height H2 from additional dielectric layer 110B, as shown in FIGS. 2-4A, depending on resistance-capacitance requirements.

An interface 120 may be present between barrier-free metal wires 116 and barrier-free metal vias 106, as shown in FIGS. 2-4B, where the non-copper conductor of barrier-free metal wires 116 meets the non-copper conductor of barrier-free metal vias 106. Interface 120 is a point of direct physical contact between barrier-free metal via 106 and barrier-free metal wire 116. Interface 120 may be between one or many surfaces of barrier-free metal via 106 and barrier-free metal wire 116. Interface 120 between barrier-free metal vias 106 and barrier-free metal wires 116 may be most apparent when barrier-free metal vias 106 and barrier-free metal wires 116 have a different material composition. However, because barrier-free metal vias 106 and barrier-free metal wires 116 may be formed in separate steps, interface 120 may exist where each barrier-free metal via 106 meets each barrier-free metal wire 116 even where barrier-free metal via 106 and barrier-free metal wire 116 have a same material composition. Although illustrated as substantially rectangular in shape, barrier-free metal wires 116 may take the form of any shape, such as rectangles, triangles, or non-polygonal shapes. As mentioned previously, barrier-free metal vias 106 may include sidewall 118A substantially vertically aligned with sidewall 118B of barrier-free metal wire 116.

In some embodiments, also shown in FIGS. 2-4B, structure 100 may include a metal wire layer 122 over barrier-free metal vias 106. Metal wire layer 122 may be a layer of conductive materials (e.g., barrier-free metal wires 116) that electrically interconnect devices in structure 100. Metal wire layer 122 may be parallel (FIGS. 4A-B) or perpendicular (FIGS. 2 and 3) to metal wires 108 thereunder. Although only one metal wire layer is illustrated, structure 100 may include any number of metal wire layers.

Still referring to FIGS. 2-4B, structure 100 may include a low-resistivity interconnect layer 124 over substrate 102. A low-resistivity interconnect layer is a collection of conductors (e.g., barrier-free metal vias 106 and metal wires 108) that may connect a metal wire to another metal wire in another conductor layer. Here, barrier-free metal vias 106 may connect metal wires 108 to barrier-free metal wire 116 in metal wire layer 122 thereover. Low-resistivity interconnect layer 124 may include any number of barrier-free metal vias 106.

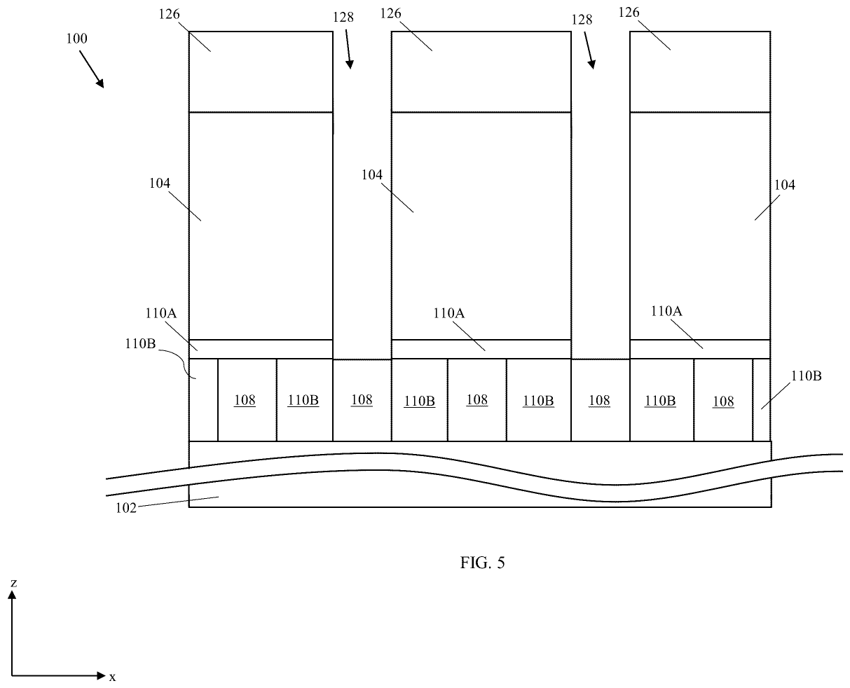

Embodiments of the disclosure provide a method to form structure 100 according to various embodiments. FIGS. 5-8 show structure 100 at various stages of back-end-of-line fabrication after forming front-end-of-devices on or near substrate 102. FIGS. 5-8 include broken lines to indicate an indeterminate number of metal and device layers between the illustrated sections. Structure 100, as in other embodiments may include substrate 102 on which other components are formed.

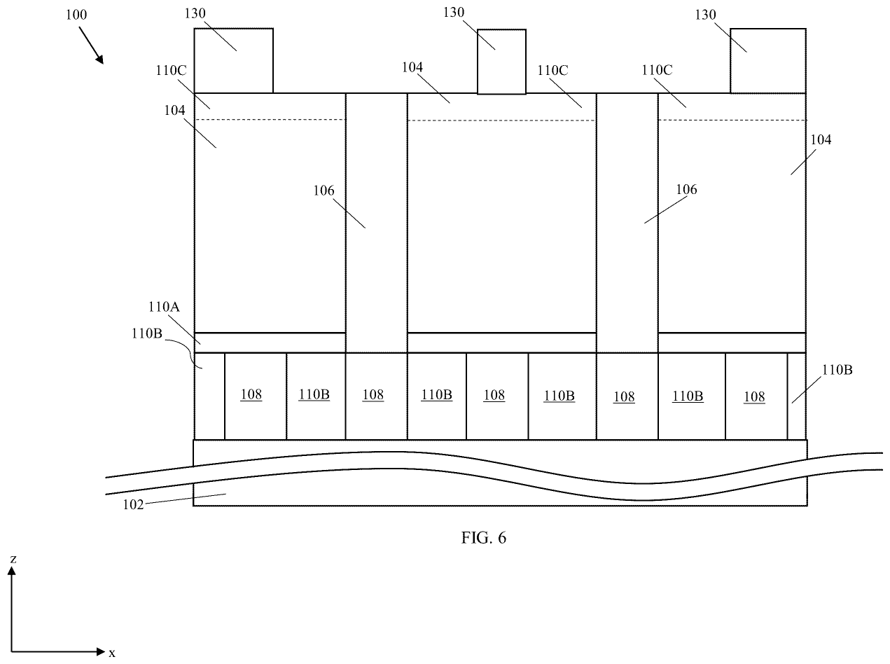

Structure 100 may include forming dielectric layer 104 over substrate 102. Dielectric layer 104 may be similar to dielectric layer 104 in other implementation described herein and may be formed over substrate 102 by any known or future fabrication methods, such as deposition. “Deposition” or “depositing” may include any now known or later developed techniques appropriate for the material to be deposited including but are not limited to, for example: chemical vapor deposition (CVD), low-pressure CVD (LPCVD), plasma-enhanced CVD (PECVD), semi-atmosphere CVD (SACVD) and high density plasma CVD (HDPCVD), rapid thermal CVD (RTCVD), ultra-high vacuum CVD (UHVCVD), limited reaction processing CVD (LRPCVD), metalorganic CVD (MOCVD), sputtering deposition, ion beam deposition, electron beam deposition, laser assisted deposition, thermal oxidation, thermal nitridation, spin-on methods, physical vapor deposition (PVD), atomic layer deposition (ALD), chemical oxidation, molecular beam epitaxy (MBE), plating, evaporation. In one embodiment, shown in FIGS. 6-8, forming structure 100 may include forming optional dielectric layer 110C (illustrated in dashed lines) over substrate 102. Optional dielectric layer 110C is similar to other dielectric layers described herein, and may be used to increase height H1 of barrier-free metal wires 116, as described fully herein. All embodiments may include or exclude forming optional dielectric layer 110C.

Still referring to FIG. 5, structure 100 may include forming a first mask 126 formed over dielectric layer 104 to form trenches 128, in which barrier-free metal vias 106 are subsequently formed (FIG. 6). A “mask” is a layer of material which is applied over an underlying layer of material, and patterned to have openings, so that the underlying layer can be processed where there are openings. After processing the underlying layer, the mask may be removed. Common masking materials are photoresist (resist) and nitride. Nitride is usually considered to be a “hard mask.” First mask 126 may include a developable organic planarization layer (OPL) on the layer to be etched, a developable anti-reflective coating (ARC) layer on the developable OPL, and a photoresist mask layer on the developable ARC layer. Masks may be removed using any known removal process appropriate for the mask material, e.g., a wet etch for hard nitride mask or an ashing process (oxygen dry strip process) for a soft resist-based mask.

In any event, still referring to FIG. 5, trenches 128 may be formed using first mask 126 to pattern portions of dielectric layer 104 using, e.g., conventional lithographic patterning techniques, as shown FIG. 5. Photolithography refers to a patterning technique where photons (i.e., light) is used to pattern a radiation-sensitive resist. In photolithography, a radiation sensitive “resist” coating is formed over one or more layers which are to be treated, in some manner, such as to be selectively doped and/or to have a pattern transferred thereto. The resist (or “photoresist”) is exposed to radiation that (selectively) passes through an intervening mask containing a pattern. As a result, the exposed or unexposed areas of the resist coating become more or less soluble, depending on the type of photoresist used. The more soluble areas of the resist are removed with a developer, leaving a patterned resist. The patterned resist can then serve as a mask for the underlying layers which can then be selectively treated, such as to receive dopants and/or to undergo etching, for example.

Still referring to FIG. 5, exposed portions of dielectric 104 may be etched to form trenches 128 by etching exposed portions of dielectric layer 104. “Etching” generally refers to the removal of material from a substrate (or structures formed on the substrate) and is often performed with a mask in place so that material may selectively be removed from certain areas of the substrate, while leaving the material unaffected, in other areas of the substrate. There are generally two categories of etching, (i) wet etch and (ii) dry etch. Wet etch is performed with a solvent (such as an acid) which may be chosen for its ability to selectively dissolve a given material (such as oxide), while, leaving another material (such as polysilicon) relatively intact. This ability to selectively etch given materials is fundamental to many semiconductor fabrication processes. A wet etch will generally etch a homogeneous material (e.g., oxide) isotropically, but a wet etch may also etch single-crystal materials (e.g., silicon wafers) anisotropically. Dry etch may be performed using a plasma. Plasma systems can operate in several modes by adjusting the parameters of the plasma. Ordinary plasma etching produces energetic free radicals, neutrally charged, that react at the surface of the wafer. Since neutral particles attack the wafer from all angles, this process is isotropic. Ion milling, or sputter etching, bombards the wafer with energetic ions of noble gases which approach the wafer approximately from one direction, and therefore this process is highly anisotropic. Reactive-ion etching (RIE) operates under conditions intermediate between sputter and plasma etching and may be used to produce deep, narrow features, such as STI trenches.

Referring now to FIG. 6, forming barrier-free metal via 106 over substrate 102 and in dielectric layer 104, i.e., in trenches 128, may include filling trenches 128 in dielectric layer 104 with a non-copper conductor be, e.g., deposition. That is, trenches 128 may be filled with a non-copper conductor to form barrier-free metal vias 106. In some embodiments, best illustrated in FIG. 1, barrier-free metal via 106 may be formed with a substantially circular cross-sectional area. As previously mentioned, barrier-free metal via 106 may be formed of a non-copper conductor, e.g., a transition metal (including ruthenium, cobalt, molybdenum, etc.), graphene, or other materials having similar properties. Although two barrier-free metal vias 106 are shown being fabricated, the method described herein may include forming any number of barrier-free metal vias 106 in low-resistivity interconnect layer 124, i.e., low-resistivity interconnect layer 124 may be formed of multiple barrier-free metal vias 106, according to the disclosure. Because barrier-free metal via 106 may include non-copper conductor, barrier-free metal via 106 may be formed as “chamferless” (i.e., without a chamfer, where the edges remain sharp and without beveling). A chamfer is a bevel or sloped edge on a device component. A chamfer is formed during a dual damascene process of forming, e.g., copper metal wires. Damascene generally refers to a process of forming metal layers in a semiconductor structure including forming an interconnect by lithographically defining a trench in a layer of dielectric (e.g., dielectric layer 104). Then, as discussed fully herein, a metal is deposited to fill resulting trenches, and any excess metal is removed by means of chemical-mechanical polishing (planarization). Dual damascene, in particular, refers to a process of forming via trenches and wiring trenches simultaneously. During a patterning step in a dual damascene process, a chamfer is typically formed in the via trench. Here, however, barrier-free metal vias 106 may be formed through a single damascene process instead of a dual damascene process because barrier-free metal vias 106 include a non-copper material. Therefore, barrier-free metal vias 106 may be chamferless.

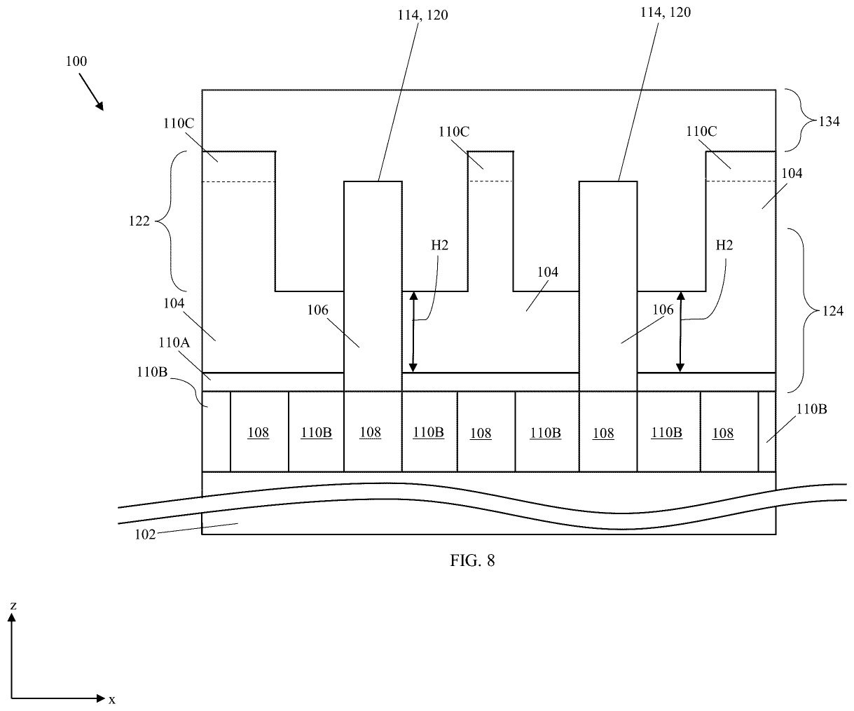

Referring now to FIGS. 6-8, forming structure 100 may include forming barrier-free metal wires 116 in dielectric layer 104, i.e., over barrier-free metal vias 106 and coupled to at least exposed portion 114 of barrier-free metal vias 106. Forming barrier-free metal wires 116 in dielectric layer 104 may include a similar process to forming barrier-free metal vias 106. Specifically, forming barrier-free metal wires 116 may include forming a second mask 130 (FIG. 6) over dielectric layer 104. Second mask 130 may be similar to first mask 126, e.g., second mask 130 may be a dielectric material placed over a structure for patterning. Exposed portions of dielectric layer 104 may be patterned (using, e.g., conventional lithographic patterning and etch techniques) to form trenches 132 (FIG. 7) and depositing a non-copper conductor (FIG. 8) in trenches 132. Once trenches 132 are formed, second mask 130 may be removed (as shown in FIG. 8). The non-copper conductor formed in trenches 132 may include an overfill 134, which is excess non-copper conductor material and is subsequently removed, as discussed fully herein. In forming barrier-free metal wires 116, interface 120 between each barrier-free metal wire 116 and each barrier-free metal via 106 may be formed, as shown in FIG. 8, because barrier-free metal wire 116 and barrier-free metal via 106 are formed at separate steps, i.e., the non-copper conductor of barrier-free metal wire 116 is formed over the non-copper conductor of barrier-free metal via 106 (as shown in FIG. 8), thereby creating interface 120 therebetween. As shown in FIGS. 2-4B, barrier-free metal wires 116 may be formed to have a substantially rectangular cross-sectional area. However, in other implementations, barrier-free metal wires 116 may take the form of any shape, e.g., circular, triangular, non-polygonal. Although two barrier-free metal wires 116 are shown being fabricated, the method described herein may include forming any number of barrier-free metal wires 116 in metal wire layer 122. That is, metal wire layer 122 may be formed of multiple barrier-free metal wires 116, according to the disclosure. In some implementations, barrier-free metal wires 116 may be formed with height H1, as illustrated in FIG. 7. Height H1 may be any possible height. As mentioned previously, optional dielectric layer 110C may be used to, e.g., modulate height H1 based on design requirements. Barrier-free metal wires 116 may also be formed with height H2 from additional dielectric layer 110B, as shown in FIGS. 7 and 8, depending on resistance-capacitance requirements.

FIGS. 2-4B show cross-sectional views of completed structure 100, according to embodiments of the disclosure after non-copper conductor overfill 134 has been removed by, e.g., chemical-mechanical planarization. Planarization refers to various processes that make a surface more planar (that is, more flat and/or smooth). Chemical-mechanical-polishing (CMP) is one currently conventional planarization process which planarizes surfaces with a combination of chemical reactions and mechanical forces. CMP uses slurry including abrasive and corrosive chemical components along with a polishing pad and retaining ring, typically of a greater diameter than the wafer. The pad and wafer are pressed together by a dynamic polishing head and held in place by a plastic retaining ring. The dynamic polishing head is rotated with different axes of rotation (that is, not concentric). This process removes material and tends to even out any “topography,” making the wafer flat and planar. Other currently conventional planarization techniques may include: (i) oxidation; (ii) chemical etching; (iii) taper control by ion implant damage; (iv) deposition of films of low-melting point glass; (v) resputtering of deposited films to smooth them out; (vi) photosensitive polyimide (PSPI) films; (vii) new resins; (viii) low-viscosity liquid epoxies; (ix) spin-on glass (SOG) materials; and/or (x) sacrificial etch-back.

Embodiments of the disclosure include a barrier-free metal via 106 and a barrier-free metal wire 116, each including a non-copper conductor. By using non-copper conductors in the structure, the structure is substantially without liners and has improved performance relative to similar structures that do not use non-copper conductors.

The method and structure as described above are used in the fabrication and operation of integrated circuit chips. The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher-level carrier) or in a multichip package (such as a ceramic carrier that has either or both surface interconnections or interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A structure, comprising:
a barrier-free metal via over a substrate and in a dielectric layer; and
a barrier-free metal wire in the dielectric layer and over the barrier-free metal via and coupled to at least an exposed portion of the barrier-free metal via,
wherein the barrier-free metal via and the barrier-free metal wire each include a non-copper conductor.

2. The structure of claim 1, wherein the non-copper conductor includes a transition metal.

3. The structure of claim 1, wherein the non-copper conductor includes one of ruthenium, cobalt, and molybdenum.

4. The structure of claim 1, wherein the non-copper conductor includes graphene.

5. The structure of claim 1, wherein the barrier-free metal via and the barrier-free metal wire have a same material composition.

6. The structure of claim 1, wherein the barrier-free metal via and the barrier-free metal wire have a different material composition.

7. The structure of claim 1, further comprising an interface between the barrier-free metal wire and the barrier-free metal via.

8. The structure of claim 1, wherein the barrier-free metal via is chamferless.

9. The structure of claim 1, wherein the barrier-free metal wire has a substantially rectangular cross-sectional area, and wherein the barrier-free metal via has a substantially circular cross-sectional area.

10. The structure of claim 1, wherein the barrier-free metal wire surrounds the exposed portion of the barrier-free metal via.

11. The structure of claim 1, wherein the barrier-free metal via includes a sidewall substantially vertically aligned with a sidewall of the barrier-free metal wire.

12. A structure, comprising:
a low-resistivity interconnect layer over a substrate, the low-resistivity interconnect layer including a barrier-free metal via in a dielectric layer; and
a barrier-free metal wire in the dielectric layer and coupled to at least an exposed portion of the barrier-free metal via,
wherein the barrier-free metal via and the barrier-free metal wire each include a non-copper conductor.

13. The structure of claim 12, wherein the barrier-free metal via includes a plurality of barrier-free metal vias.

14. The structure of claim 12, wherein the barrier-free metal via is chamferless.

15. The structure of claim 12, wherein the barrier-free metal via and the barrier-free metal wire have a same material composition.

16. The structure of claim 12, wherein the barrier-free metal via and the barrier-free metal wire have a different material composition.

17. A method of forming a structure, comprising:
forming a barrier-free metal via over a substrate and in a dielectric layer; and
forming a barrier-free metal wire in the dielectric layer and over the barrier-free metal via and coupled to at least an exposed portion of the barrier-free metal via,
wherein the barrier-free metal via and the barrier-free metal wire each include a non-copper conductor.

18. The method of claim 17, further comprising an interface between the barrier-free metal wire and the barrier-free metal via.

19. The method of claim 17, wherein the barrier-free metal via is chamferless.

20. The method of claim 17, wherein the barrier-free metal wire has a substantially rectangular cross-sectional area, and wherein the barrier-free metal via has a substantially circular cross-sectional area.
